(19) United States
(12) Patent Application Publication
(10) Pub. No.: US 2023/0106564 A1
(43) Pub. Date: Apr. 6, 2023

(54) MULTI-FUNCTIONAL TAG FOR THROUGHOUT THE PLANT LIFE CYCLE

(71) Applicant: Tadbik Advanced Technologies Ltd., Petach Tikva (IL)

(72) Inventors: Guy GOLDBERG, Herzelia (IL); Michal Yanuv MAX, Modiin (IL)

(21) Appl. No.: 17/958,410

(22) Filed: Oct. 2, 2022

(30) Foreign Application Priority Data
Oct. 3, 2021 (IL) 286933

(51) Int. Cl. A01G 9/00; G09F 3/00; G09F 3/02; B32B 7/12; B32B 25/08; B32B 25/20; B32B 27/08; B32B 27/32; B32B 27/30; B32B 27/36; B32B 27/40; B32B 27/34

(52) U.S. Cl. CPC A01G 9/006; B32B 7/12; B32B 25/08; B32B 25/20; B32B 27/08; B32B 27/32; B32B 27/34; B32B 27/36; B32B 27/40; B32B 27/304; B32B 27/308; B32B 27/365; G09F 3/02; G09F 3/0297; B32B 2250/24; B32B 2307/712; B32B 2519/02; G09F 2003/0202; G09F 2003/0255; G09F 2003/0257; G09F 2003/0269; G09F 2003/0272

(57) ABSTRACT

A multi-functional tag for marking cultivated plants and agricultural product throughout the whole plant and product cycle.

### CROSS REFERENCE TO RELATED APPLICATIONS

This application claims the benefit of priority of Israel Patent Application No. 286933 filed Oct. 3, 2021, the contents of which are all incorporated herein by reference in their entirety.

### FIELD OF THE INVENTION

The invention is in the field of plant tags for marking cultivated plants and agricultural product throughout the whole plant and product cycle.

### BACKROUND OF THE INVENTION

Tags are commonly used for marking plants during after planting and throughout the stages of plant growth. However, different stages of growth necessitate different modes of attachment, depending on the characteristics of the plant.

In addition, tags have been configured to present information regarding the plant in different modes, such as visual, graphic data and electronic data (such as RFID).

U.S. Application US 2004/0237368A1 discloses a label for plants, including a plastic or resin material, at least one Section with a Surface Suitable for printing, and at least one Section with means for holding the label to the plant, the Surface including a porous structure.

EP Application EP 2808840 A1 According to an aspect of the invention, an RFID-enabled plant label is conceived which comprises an RFID-tag integrated circuit, an RFID antenna being coupled to the RFID-tag integrated circuit and a soil moisture sensor being coupled to the RFID-tag integrated circuit, wherein the RFID-tag integrated circuit is arranged to receive soil moisture measurement results from a soil moisture sensor.

U.S. Pat. US 9569987 B2 discloses a label with which, among other things, vegetables, for instance vine tomatoes, fruit and house plants, can be supplied with information. The label is a three-dimensional object obtained by folding and gluing a punched or cut piece of paper, cardboard or another type of thin-walled material, which object can be attached to one or more branches of a vine of tomatoes and whereby at least one surface area of the three-dimensional object is visible in Such a way that it can serve as an information-bearing Surface.

U.S. Pat. US 9330581 B2 discloses A device configured to retain an informational tag, near a plant in a positioning step and an attaching step. The device includes a display bed that defines a plane. A shoulder is defined on one side of the frame such that the shoulder extends away from the display bed and defines a stop. retaining finger extends over the plane and defines a Surface that faces and is spaced-away from the plane. A cover is positioned near the retaining finger and is movable from a first position to a second position. A prong is positioned on the cover and extends toward the plane when the cover is in the first position and extends through the plane when the cover is in the second position. The retaining finger surface and the Field of Classification Search display bed are configured to act cooperatively to retain a tag therebetween by friction.

U.S. Pat. US 8314701 B2 discloses a method for the traceability of plants after field planting and during the whole productive and commercial cycle, by means of the RFID (Radio Frequency Identification) Tags technology, comprising: 1) marking of the plants by the grafting of radio-frequency microchips containing information relating to the plant it-self, directly in the trunk or other parts of the plant or by means of external systems; 2) handling and display of the traceability data by means of a suitable software system.

U.S. Pat. US 8373563 B2 discloses a system for tracking at least one plant includes an electronic tag including an interrogation interface and memory circuitry and a package for the electronic tag, the package being con figured for physical association with at least one corresponding plant. The package may be configured for self-contained physical association with the at least one plant. The electronic tag may be interrogated by multiple trading partners in a Supply chain.

Expired U.S. Pat. 4379372 discloses a plant tag is provided for placement on a plant. The plant tag has a resilient tag portion with first and second holes formed therethrough. Guide notches are provided at exposed edges of the tag portion on either side of a scored line. Cuts extend from each of the first and second holes to a guide surface on the same side of the scored line. The tag is foldable about the scored line to align the first and second holes. The guide surfaces guide the tag onto the plant with the edges of the cuts being separated to permit the plant to pass through and into the first and second holes. The resilient tag unfolds to lock the tag on the plant and the cuts are nonaligned to form tabs to lock the tag to the plant by resisting simultaneous separation of the edges of the cuts.

U.S. Application 8205789 B2 discloses a plant handling, tagging and shipping system includes a flood trailer towed by a cart for delivering potted plants from a grow site to a prepping station while also soaking the pots, an on-demand tag-printing system for printing plant tags based on customized client data, and a conveyor system that enables workers to trim, weed, clean, and tag the plants as they travel along the conveyor.

There exists a long felt need for a mold in place label.

### SUMMARY OF THE INVENTION

It is the object of the present invention to present a multi-functional tag for marking a plant thorough out the plants life cycle, comprising:
a first layer comprising visual data;
a second layer comprising electronic circuit;
a third layer; and
a pressure-sensitive adhesive configured to bind the two layers;
wherein the tag is configured to attach to the plant in a plurality of modes.

A multi-functional tag for marking a plant thorough out the plants life cycle, comprising:
at least one attachment for marking the plant without attaching to the plant; and
at least one attachment for marking the plant;
wherein the tag comprises three layers:
   a first layer comprising visual data;
   a second layer comprising electronic circuit;
   a third layer; and
   a pressure-sensitive adhesive configured to bind the layers;

It is another object of the present invention to present a tag as presented in any of the above, wherein the first layer is laminated to the third layer using pressure sensitive adhesive.

It is another object of the present invention to present a tag as presented in any of the above, wherein the adhesive is selected from a group consisting of acrylic, acrylate, silicone, polyurethane and rubber.

It is another object of the present invention to present a tag as presented in any of the above, wherein the layers have a thickness of at least 50 microns.

It is another object of the present invention to present a tag as presented in any of the above, wherein the layers are constructed from a material selected from a group consisting of HDPE, PP, PE, PVC, PC, PET and PA.

It is another object of the present invention to present a tag as presented in any of the above, wherein the visual data is selected from a group consisting of graphics, printed characters and barcodes.

It is another object of the present invention to present a tag as presented in any of the above, wherein the third layer additionally comprises an electronic communication unit.

It is another object of the present invention to present a tag as presented in any of the above, wherein the electronic communication unit comprises an antenna and integrated circuit (IC).

It is another object of the present invention to present a tag as presented in any of the above, wherein the third layer additionally comprises a battery.

It is another object of the present invention to present a tag as presented in any of the above, wherein the electronic communication unit is characterized as RFID, NFC or BLE.

It is another object of the present invention to present a tag as presented in any of the above, wherein the attachment modes are selected from a group consisting of attaching to at least one part of a plant, attaching to at least part of a container, inserting in the earth and placing on the earth.

It is another object of the present invention to present a tag as presented in any of the above, wherein the tag additionally comprising perforation placed between sat modes of attachment.

It is another object of the present invention to present a tag as presented in any of the above, wherein the first and second layers are configured as at least one sticker.

It is another object of the present invention to present a tag as presented in any of the above, wherein the pressure-sensitive adhesive binding the second and third layers is characterized as a low-tack pressure-sensitive adhesive.

It is another object of the present invention to present a tag as presented in any of the above, wherein the tag comprises at least one attachment for marking a packaged plant or plant part.

It is another object of the present invention to present a tag as presented in any of the above, wherein the tag comprises at least one attachment for marking a harvested plant, plant part or package.

It is the object of the present invention to present a method of marking a plant throughout the life cycle, comprising steps of:
obtaining the tag as presented in any of the above;
marking the seed position of a plant in the ground or a container with the tag, using the first mode;
attaching the tag to the plant, where the plant is strong enough to hold the tag,
wherein the tag is attached to the ground or container using a first mode of attachment and is attached to the plant using a second mode of attachment;

It is another object of the present invention to present a method as presented in any of the above, additional comprising a step of tracking the growth of the plant.

It is another object of the present invention to present a method as presented in any of the above, wherein the tracking is conducted by reading visual or electronic data of the tag.

It is another object of the present invention to present a method as presented in any of the above, additional comprising a step of attaching the tag to a package containing a harvested plant, plant part or plant product.

It is another object of the present invention to present a XX as presented in any of the above

### DETAILED DESCRIPTION OF THE PREFERRED EMBODIMENTS

The accompanying drawings, which are included to provide a further understanding of the invention and are incorporated in and constitute a part of this specification, illustrate embodiments of the invention and together with the description serve to explain the principles of the invention wherein:

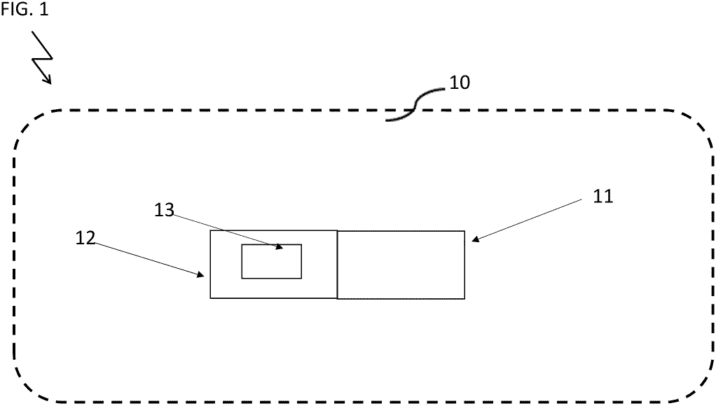

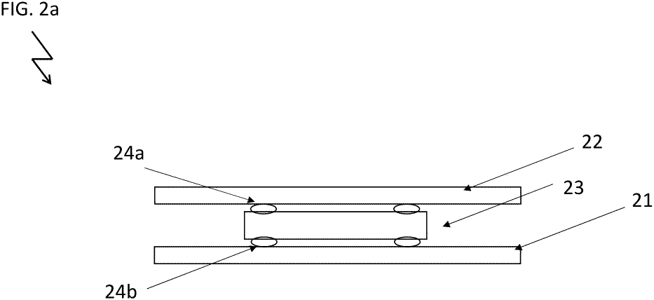

FIG. 1 - presents a schematic representation of a tag with two segments

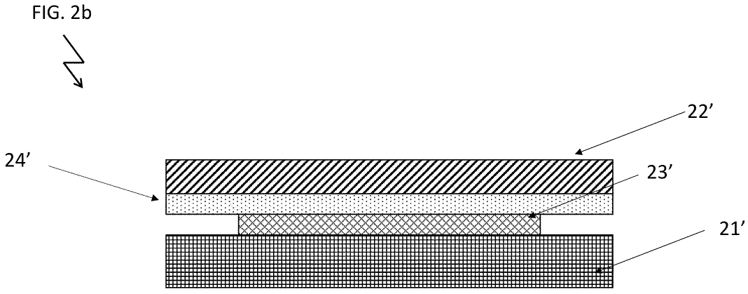

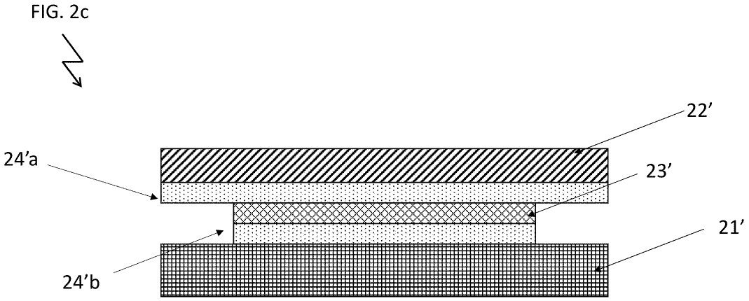

FIGS. 2a, 2b, 2c - presents a schematic representation of a multi-layer tag

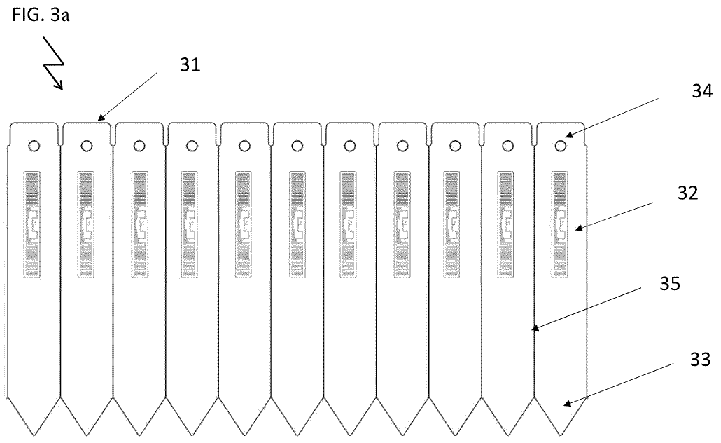

FIGS. 3a, 3b, 3c - demonstrates an example of the tag of the present invention

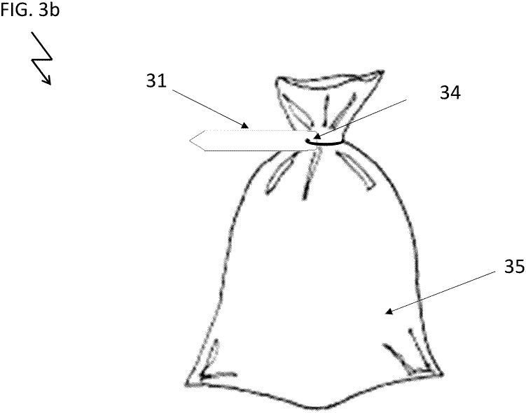

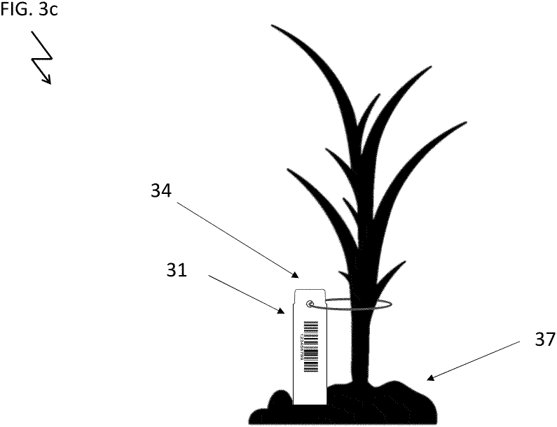

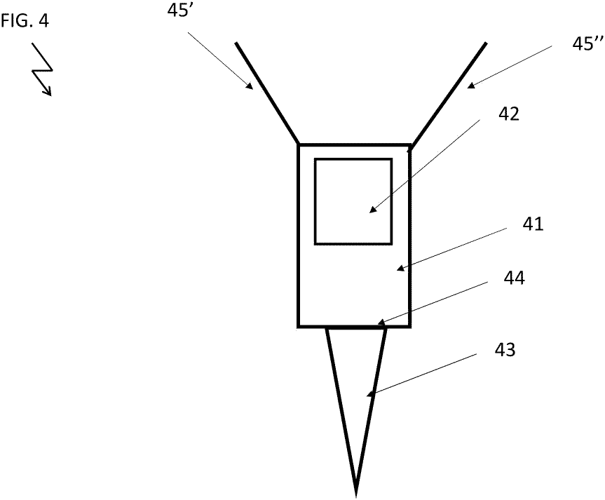

FIG. 4 - presents an embodiment of the tag of the present invention

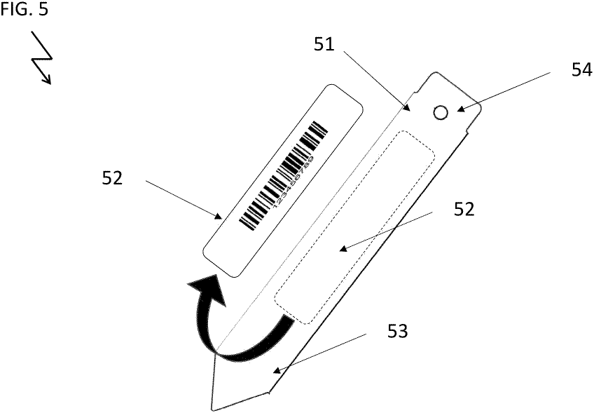

FIG. 5 - presents an embodiment of the tag of the present invention

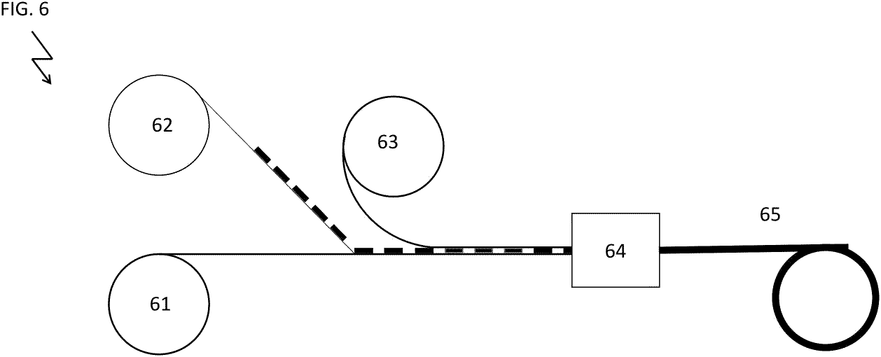

FIG. 6 - presents a method of manufacturing the tag of the present invention

### DETAILED DESCRIPTION OF THE PREFERRED EMBODIMENT

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

In this application the term “Radio-frequency identification (RFID)” refers to and identification system that uses electromagnetic fields to automatically identify at item with a label (or tag). In many embodiments, an RFID system consists of a radio receiver, a (tiny) radio transponder and transmitter. When triggered by an electromagnetic interrogation pulse from a nearby RFID reader, the tag transmits a signal comprising digital data, such as an identifying inventory number, to the reader. This system can enable the rapid identification and tracking of items and containers.

In this application the term “Near-field communication” (NFC) refers to a technology which can be used for contactless exchange of data over short distances. There a numerous NFC standard that regulate communication protocols and data exchange formats for NFC device(s).

In this application the term “ Bluetooth Low Energy” (Bluetooth LE or BLE) refers to a low energy protocol that acts as a wireless personal area network technology. What else does BLE need?

Passive BLE is like passive RFID - there is an antenna and IC, the energy come from a reader or gateway, there is an energy harvesting and the response is transmitted back to the reader/gateway.

As used herein, the term “thermoplastic” (or “thermosoftening plastic”) refers to a plastic or polymer material that becomes pliable (and therefore moldable) when heated at or above a certain temperature and solidifies upon cooling.

As used herein, the term “PE” refers to polyethylene (or polythene), a commonly used thermoplastic polymer. “HDPE” (or “PEHD”) refers to High-density polyethylene (or polyethylene high-density). Other common thermoplastic polymers that can be used are Polypropylene (also known as polypropene) ‘PP’, Polyvinyl chloride “PVC”, Polycarbonates “PC”, Polyethylene terephthalate “PET” or “PETE” and polyamide “PA”.

Unless otherwise stated, with reference to numerical quantities, the term “about” refers to a tolerance of ±25% of the stated nominal value.

Unless otherwise stated, all numerical ranges are inclusive of the stated limits of the range.

### Detailed Description of the Present Invention

Identification tag was developed to serve as an integral part of a monitoring system and as a tool for success in a convenient and reliable solution for different types of agricultural crops tracking. The tag is designated to accompany the plant at all stages, from the moment it is implanted until it is harvested.

RFID labels can be characterized as active or passive. Passive tags are powered by energy of the radio waves, emitted by the RFID reader. Active tags additionally comprise a power source (such as a battery) and can therefore be read by the RFID reader at much greater ranges (up to hundreds of meters).

The RFID can be replaced by any passive element that is able to transmit and/or receive RF (RFID, NFC, Bluetooth, BLE or any other frequency on the spectrum).

In some embodiments, two NFC-capable devices (such a tag and a reader) can be connected via a point-to-point contact over a distance of up to 20 cm. This connection can be used to exchange data (such as process data and maintenance and service information) between the devices.

NFC is based on inductive coupling between two “antennas” in the NFC-enabled devices (such as a tap and a reader) to enable communicating in one or both directions. NFC typically used a frequency of 13.56.

The current invention, is described as follows:

A single tag, with a multiple mode of attachment or connection and operation, without the need of any additional components for continued use, throughout the plant different stages of growth. Reference is made to FIG. 1, showing a schematic representation of a tag 10 with two segments, one segment for attaching to a plant 11, and one segment for attaching to a container or the earth 12, with the tag having a segment having information regarding the plant 13.

In some embodiments, the tag has at least two modes:
The first is configured for the first stage(s) of the plant’s life cycle. For the first stages of grown the tag is configured to not need the support of the plant for marking the plant. The tag could be placed in the ground next to each young seedling, contain s spike-like segment for inserting into the ground of a holder for attaching to the plant container.
The second is configured for attaching to a mature plant. In some embodiments, the plant is mature enough to support the weight of the tag. In some embodiments, the tag can be connected to the seedling using tie (such as a zip tie, a tie etc) that is bound to the stronger part of the plant (such as the seedling’s main stem), through the hole that is placed on the top of the tag.

In some embodiments, the tag can be separated from the first mode of attachment, when the second mode is utilized. The separation can be by the use of scissors (or another blade), or by inserting a perforation during production.

In some embodiments, the tag(s) can be delivered in a continuous-roll form factor. The continuous-roll form enables continuous manufacturing, a process which is very efficient. It is also enabling the option to print and encode the tag(s) on site using RFID/BLE printers.

The tag of the present invention comprises three layers (FIG. 2a)
1. A top/outer layer 21 constructed from a weather resistant material (such as PP, PE, PVC, PC, PET, PA or a blend thereof), at a thickness of 50-1000 µm. In some embodiments, the outer layer contains visual/graphic data, such as a barcode, text, and graphics.
2. A middle layer 23 comprising an electronic element (such as a RFID or BLE element), such as Gen2 UHF RFID inlay or any other RF element. In some embodiments, the middle layer has a smaller surface size that the two protective layers.
3. A bottom layer 22 constructed from a weather resistant material (such as PP, PE, PVC, PC, PET, PA or a mixture thereof), at a thickness of 50-1000 µm.

The tag additionally comprises two layers of pressure-sensitive-adhesive 24(a,b), positioned to bond the three layers.

Reference is made to FIGS. 2(b,c), showing other embodiments of the tag:
1. A top/outer layer 21ʹ constructed from a weather resistant material (such as PP, PE, PVC, PC, PET, PA or a blend thereof), at a thickness of 50-1000 µm. In some embodiments, the outer layer contains visual/graphic data, such as a barcode, text, and graphics.
2. A middle layer 23′ comprising an electronic element (such as a RFID or BLE element), such as Gen2 UHF RFID inlay or any other RF element. In some embodiments, the middle layer has a smaller surface size that the two protective layers.
3. A bottom layer 22′ constructed from a weather resistant material (such as PP, PE, PVC, PC, PET, PA or a mixture thereof), at a thickness of 50-1000 µm.

The tag additionally comprises one (FIG. 2b) or two layers (FIG. 2c) of pressure-sensitive-adhesive 24′(a,b), positioned to bond the three layers.

The RFID component comprises 2 main elements:
an antenna for receiving and transmitting the signal. The antenna can be produced by printing (with conductive ink), die cut aluminum/cupper, etching (on another carrier) and
an integrated circuit (IC), a microchip, configured to store and process information and modulates and demodulates radio-frequency (RF) signals. The IC can be connected by various methods, such as flip chip and direct chip.

In some embodiments, the data is stored in a non-volatile memory, inside the IC.

The RFID tag can comprise fixed or programmable logic for processing the transmission and sensor data, respectively. Tags can be characterized as read-only (having a factory-assigned ID number), or as read/write (where ID data can be written into the tag by the system user).

The RFID tag can be categorized as passive, active or power-assisted passive. An active tag has a power source (such as a battery), enabling the transmission of its (ID) signal. A power-assisted passive tag has a power source (such as a small battery) and is activated in the presence of an RFID reader. A passive uses the radio energy transmitted by the reader.

### Example 1

Reference is made to FIG. 3a, showing the construct of an embodiment of the invention, comprising a plurality of tags 31, having an electronic element 32, a sharp section 33 and an opening for tying the tag 34, connected by a perforation 35 for easy separation. The separated tag can be placed on the ground, next to the seed (or seedling), before being attached to the larger plant.

Reference is made to FIG. 3b, showing the tag 31, connected to a bag 36, with the tie opening 34 and to FIG. 3c, showing the tag 31, connected to a plant 37, with the tie opening 34.

### Example 2

Reference is made to FIG. 4, showing the construct of an embodiment of the invention, showing a tag, comprising a main body 41, having an electronic element 42, connected to a spike 43, configured to placing in the earth and to two ties 45′/45″, configured to tying to the plant. In some embodiment, the spike 43 and main body 41, are attached by a perforation 44 for easy separation. The spike-tag can be placed in the ground, next to the seed (or seedling), while the plant is note strong enough to hold the weight of the tag.

### Example 3

Reference is made to FIG. 5, showing the construct of an embodiment of the invention, comprising a tag 31, having one or more removable electronic element and barcode label 32, that can be peeled off from the tag, so as to be stuck on a package or a document. In some embodiments, this came be used as a sticker or post-it.

### Example 4

Reference is made to FIG. 6, showing a method of constructing the tag of the present invention, comprising feeding a reel of the plastic film 61, a reel of the electronic element 62, a reel of the plastic film 63, and being placing in a die cutter 64, to produce the final product 65, a roll of tags.

1-21. (canceled)

22. A multi-functional one-piece tag for marking a plant throughout a life cycle of the plant, comprising:
A. a first layer comprising visual data;
B. a second layer comprising electronic circuit;
C. a layer comprising an electronic circuit; and
D. at least one layer of a pressure-sensitive adhesive configured to bind said two layers;
wherein said tag comprises elements configured to attach to the plant in a plurality of modes of attachment.

23. The multi-functional one-piece tag of claim 22, wherein at least one of the following is true:
A. said first layer is laminated to said layer comprising an electronic circuit using pressure sensitive adhesive;
B. said adhesive is selected from a group consisting of acrylic, acrylate, silicone, polyurethane and rubber; and
C. said pressure-sensitive adhesive binding said second and layer comprising an electronic circuits is characterized as a low-tack pressure-sensitive adhesive.

24. The multi-functional one-piece tag of claim 22, wherein at least one of the following is true:
A. each of said layers have a thickness of at least 50 microns; and
B. said layers are constructed from a material selected from a group consisting of HDPE, PP, PE, PVC, PC, PET, TPU and PA.

25. The multi-functional one-piece tag of claim 22, wherein said visual data is selected from a group consisting of graphics, printed characters or barcodes.

26. The multi-functional one-piece tag of claim 22, wherein said layer comprising an electronic circuit additionally comprises an electronic communication unit, at least one of the following being true:
A. said electronic communication unit comprises an antenna and integrated circuit (IC);
B. said layer comprising an electronic circuit additionally comprises a battery; and
C. said electronic communication unit is characterized as RFID, NFC or BLE.

27. The multi-functional one-piece tag of claim 22, wherein said plurality of modes of attachment are selected from a group consisting of attaching to at least one part of a plant, attaching to at least part of a container, inserting in the earth or placing on the earth.

28. The multi-functional one-piece tag of claim 22, wherein said tag additionally comprises perforation placed between at least two of said plurality of modes of attachment.

29. The multi-functional one-piece tag of claim 22, wherein said first and second layers are configured as at least one sticker.

30. The multi-functional one-piece tag of claim 22, wherein at least one of the following is true:
A. at least one of said plurality of modes of attachment comprises attachment for marking a packaged plant or plant part; and
B. at least one of said plurality of modes of attachment comprises attachment for marking a harvested plant, plant part or package.

31. A multi-functional one-piece tag for marking a plant thorough out a life cycle of the plant, comprising:
A. at least one attachment for marking at least one of the position of said plant or plant product, or the container of said plant or plant product; and
B. at least one attachment for marking said plant;
wherein said tag comprises three layers:
a first layer comprising visual data;
a second layer comprising electronic circuit;
a layer comprising an electronic circuit; and
at least one layer of a pressure-sensitive adhesive configured to bind said layers.

32. The multi-functional one-piece tag of claim 31, wherein at least one of the following is true:
a. said first layer is laminated to said layer comprising an electronic circuit using pressure sensitive adhesive;
b. said adhesive is selected from a group consisting of acrylic, acrylate, silicone, polyurethane and rubber; and
c. said pressure-sensitive adhesive binding said second and layer comprising an electronic circuits is characterized as a low-tack pressure-sensitive adhesive.

33. The multi-functional one-piece tag of claim 31, wherein at least one of the following is true:
a. each of said layers have a thickness of at least 50 microns; and
b. said layers are constructed from a material selected from a group consisting of HDPE, PP, PE, PVC, PC, PET, TPU and PA.

34. The multi-functional one-piece tag of claim 31, wherein said visual data is selected from a group consisting of graphics, printed characters or barcodes.

35. The multi-functional one-piece tag of claim 31, wherein said layer comprising an electronic circuit additionally comprises an electronic communication unit, at least one of the following being true:
a. said electronic communication unit comprises an antenna and integrated circuit (IC);
b. said layer comprising an electronic circuit additionally comprises a battery; and
c. said electronic communication unit is characterized as RFID, NFC or BLE.

36. The multi-functional one-piece tag of claim 31, wherein said plurality of modes of attachment are selected from a group consisting of attaching to at least one part of a plant, attaching to at least part of a container, inserting in the earth or placing on the earth.

37. The multi-functional one-piece tag of claim 31, wherein said tag additionally comprises perforation placed between at least two of said plurality of modes of attachment.

38. The multi-functional one-piece tag of claim 31, wherein said first and second layers are configured as at least one sticker.

39. The multi-functional one-piece tag of claim 31, wherein at least one of the following is true:
a. at least one of said plurality of modes of attachment comprises attachment for marking a packaged plant or plant part; and
b. at least one of said plurality of modes of attachment comprises attachment for marking a harvested plant, plant part or package.

40. A method of marking a plant throughout a life cycle of the plant, comprising steps of:
A. obtaining a multi-functional one-piece tag comprising:
i. a first layer comprising visual data;
ii. a second layer comprising electronic circuit;
iii. a layer comprising an electronic circuit; and
iv. a pressure-sensitive adhesive configured to bind said two layers;
B. marking the seed position of a plant in the ground or a container with said tag, using a first mode of attachment;
C. attaching the multi-functional one-piece tag to said plant using a second mode of attachment, at such time as said plant is strong enough to hold said tag,
wherein said tag is attached to ground or a container using said first mode of attachment and is attached to said plant using said second mode of attachment.

41. The method of claim 40, additionally comprising at least one of the following steps:
a. tracking the growth of said plant, said tracking being conducted by reading visual or electronic data of said tag; and
b. attaching said multi-functional one-piece tag to a package containing a harvested plant, plant part or plant product.
